(19) United States
(12) Patent Application Publication
(10) Pub. No.: US 2012/0175035 A1
(43) Pub. Date: Jul. 12, 2012

(54) Three-Layer Steel Cord that is Rubberized in Situ and has a 2+M+N Structure

(75) Inventors: Jeremy Toussain, Clemont-Ferrand (FR); Thibaud Pottier, Clermont-Ferrand (FR)

(73) Assignees: Michelin Recherche et Technique S.A., Paccot (CH); Societe de Technologie Michelin, Clermont-Ferrand (FR)

(21) Appl. No.: 13/382,147

(22) PCT Filed: Jul. 2, 2010
(86) PCT No.: PCT/EP10/59486

§ 371 Date: Mar. 26, 2012

(30) Foreign Application Priority Data
Jul. 3, 2009 (FR) 0954598

(51) Int. Cl. B60C 9/18; B60C 9/02; D07B 1/06

(52) U.S. Cl. 152/527; 57/217; 152/556

(57) ABSTRACT

Metal cord with three layers (C1+C2+C3) of 2+M+N construction, rubberized in situ, comprising a first layer or central layer (C1) comprised of two wires (10) of diameter d₁ assembled in a helix at a pitch p₁, around which central layer there are wound in a helix at a pitch p₂, in a second layer (C2), M wires (11) of diameter d₂, around which second layer there are wound in a helix at a pitch p₃, in a third layer (C3), N wires (12) of diameter d₃, the said cord being characterized in that it has the following characteristics (d₁, d₂, d₃, p₁, p₂ and p₃ being expressed in mm): 0.08≦d₁≦0.50; 0.08≦d₂≦0.50; 0.08≦d₃≦0.50; 3<p₁<50; 6<p₂<50; <p₃<50; over any 3 cm length of cord, a rubber composition called “filling rubber” is present in each of the capillaries delimited by, on the one hand, the 2 wires of the first layer (C1) and the M wires of the second layer (C2), and on the other hand the M wires of the second layer (C2) and the N wires of the third layer (C3); the content of filling rubber in the cord is comprised between 10 and 50 mg per gram of cord. Method of manufacturing such a cord. Multi-strand rope at least one of the strands of which is a metal cord with three layers (C1) rubberized in situ, in accordance with the invention.

The present invention relates to three-layer metallic cords that can be used notably for reinforcing articles made of rubber such as tires for industrial vehicles.

The invention more particularly relates to three-layer metallic cords of the type “rubberized in situ”, i.e. cords that are rubberized from the inside, during their actual manufacture, with rubber or a rubber composition in the uncrosslinked (uncured) state.

This invention relates more specifically to three-layer metal cords of specific 2+M+N construction and to their use in carcass reinforcements, also called “carcasses” of tires for industrial vehicles.

As is known, a radial tire comprises a tread, two inextensible beads, two sidewalls connecting the beads to the tread and a belt positioned circumferentially between the carcass reinforcement and the tread. This carcass reinforcement is made up in the known way of at least one ply (or “layer”) of rubber which is reinforced with reinforcing elements (“reinforcers”) such as cords or monofilaments, generally of the metallic type in the case of tires for industrial vehicles.

To reinforce the above carcass reinforments, use is generally made of known as steel cords made up of a central layer and one or more concentric layers of wires positioned around this central layer. The three-layered cords most often used are essentially cords of L+M+N construction formed of a central layer of L wires surrounded by at least one layer of M wires itself surrounded by an external layer of N wires.

Among the three-layered cords which may be used these days in carcass reinforcements for tires for industrial vehicles, where the aim is to achieve the greatest mechanical strength and accordingly a large number of wires is needed, those that are particularly known are cords of 2+M+N construction consisting of a central layer of 2 wires surrounded by an intermediate layer of M wires, itself surrounded by an outer layer of N wires, it being possible for the entire assembly to be wrapped with an external wrapping wire wound in a helix around the outer layer.

As is well known, these layered cords are subjected to high stresses when the tires are running along, notably to repeated bendings or variations in curvature which, at the wires, give rise to friction, notably as a result of contact between adjacent layers, and therefore to wear, as well as fatigue; they therefore have to have high resistance to what is known as “fretting fatigue”.

It is also particularly important for them to be impregnated as far as possible with the rubber, for this material to penetrate thoroughly into all the spaces between the wires that make up the cords. Indeed, if this penetration is insufficient, empty channels are then formed along the cords, and corrosive agents, such as water or even the oxygen in the air, liable to penetrate the tires, for example as a result of cuts, travel along these empty channels into the carcass of the tire. The presence of this moisture plays an important role in causing corrosion and accelerating the above degradation processes (the so-called “corrosion fatigue” phenomena), as compared with use in a dry atmosphere.

All these fatigue phenomena that are generally grouped under the generic term “fretting corrosion fatigue” cause progressive degeneration of the mechanical properties of the cords and may, under the severest running conditions, affect the life of these cords.

To alleviate the above disadvantages, application WO 2005/071157 has proposed three-layered cords of L+M+N construction, L varying from 1 to 4, M from 3 to 12 and N from 8 to 20, particularly of 1+M+N construction, one of the essential features of which is that a sheath consisting of a diene rubber composition covers at least the intermediate layer made up of the M wires, it being possible for the central layer of wires itself either to be covered or not to be covered with rubber. Thanks to this special design, not only is excellent rubber penetrability obtained, limiting problems of corrosion, but the fretting fatigue endurance properties are also notably improved over the cords of the prior art. The longevity of the industrial vehicle tires and that of their carcass reinforcements are thus very appreciably improved.

However, the described methods for the manufacture of these cords, and the resulting cords themselves, are not free of disadvantages.

First of all, these three-layer cords are obtained in several steps which have the disadvantage of being discontinuous, firstly involving creating an intermediate L+M cord, then sheathing this intermediate cord or core using an extrusion head, and finally a final operation of cabling the remaining N wires around the core (L+M) thus sheathed, in order to form the outer layer. In order to avoid the problem of the very high tack of uncured rubber of the rubber sheath before the outer layer is cabled around the core, use must also be made of a plastic interlayer film during the intermediate spooling and unspooling operations. All these successive handling operations are punitive from the industrial standpoint and go counter to achieving high manufacturing rates.

Further, if there is a desire to ensure a high level of penetration of the rubber into the cord in order to obtain the lowest possible air permeability of the cord along its axis, it has been found that it is necessary using these methods of the prior art to use relatively high quantities of rubber during the sheathing operation. Such quantities lead to more or less pronounced unwanted overspill of uncured rubber at the periphery of the as-manufactured finished cord.

Now, as has already been mentioned hereinabove, because of the very high tack that rubber in the uncured (i.e. uncrosslinked) state has, such unwanted overspill in turn gives rise to appreciable disadvantages during later handling of the cord, particularly during the calendering operations which will follow for incorporating the cord into a strip of rubber, likewise in the uncured state, prior to the final operations of manufacturing the tire and final curing.

All of the above disadvantages of course slow down the industrial production rates and have an adverse effect on the final cost of the cords and of the tires they reinforce.

Another disadvantage that arises, this one specific to cords of 2+M+N construction, is that the 2 wires of the central layer remain in contact with one another within the cord and this, as is known, is detrimental to their fatigue-corrosion endurance.

While pursuing their research, the Applicants have discovered an improved three-layered cord, of 2+M+N construction, obtained by using a specific method of manufacture which is able to alleviate the abovementioned drawbacks.

Accordingly, a first subject of the invention is a metal cord with three layers (C1, C2, C3) of 2+M+N construction, rubberized in situ, comprising a first layer or central layer (C1) consisting of two wires of diameter d₁ wound in a helix at pitch p₁, around which first layer there are wound in a helix at a pitch p₂, in a second layer or intermediate layer (C2), M wires of diameter d₂, around which second layer there are wound in a helix at a pitch p₃, in a third layer or external layer (C3), N wires of diameter d₃, the said cord being characterized in that it has the following characteristics (d₁, d₂, d₃, p₁, p₂ and p₃ being expressed in mm):
0.08≦d₁≦0.50;
0.08≦d₂≦0.50;
0.08≦d₃≦0.50;
3<p₁<50;
6<p₂<50;
9<p₃<50;
over any 3 cm length of cord, a rubber composition called “filling rubber” is present in each of the capillaries delimited by, on the one hand the 2 wires of the first layer (C1) and the M wires of the second layer (C2), and on the other hand the M wires of the second layer (C2) and the N wires of the third layer (C3);
the content of filling rubber in the cord is comprised between 10 and 50 mg per gram of cord.

This three-layered cord of the invention, when compared with the three-layered cords rubberized in situ of the prior art, has the notable advantage of containing a smaller amount of filling rubber, which makes it more compact, this rubber also being distributed uniformly inside the cord, inside each of its capillaries, thus giving it optimum impermeability along its axis.

The invention also relates to the use of such a cord for reinforcing semifinished products or articles made of rubber, for example plies, hoses, belts, conveyor belts and tires.

The cord of the invention is most particularly intended to be used as a reinforcing element for a carcass reinforcement of a tire for industrial vehicles (i.e. vehicles which bear heavy loads), such as vans and vehicles known as heavy goods vehicles, that is to say underground rail vehicles, buses, heavy road transport vehicles such as lorries, tractors, trailers or even off-road vehicles, agricultural or civil engineering machinery and any other type of transport or handling vehicle.

The invention also relates to these semifinished products or articles made of rubber themselves when they are reinforced with a cord according to the invention, particularly the tires intended for industrial vehicles such as vans or heavy goods vehicles.

The invention also relates to a method of manufacturing the cord of the invention, the said method comprising at least the following steps:
a first step of assembling by twisting the two wires of the central layer to form, at a first point called “first assembling point” the first layer or central layer (C1);
a second assembling step by twisting the M wires around the central layer (C1) to form, at a second point called “second assembling point”, an intermediate cord (C1+C2) called “core strand” of 2+M construction;
downstream of the first assembling point, a sheathing step in which the central layer (C1) and/or the core strand (C1+C2) is/are sheathed with a filling rubber in the uncured state, this sheathing being conducted either upstream or downstream or both upstream and downstream of the second assembling point;
followed by a third assembling step by twisting or cabling the N wires around the core strand thus sheathed;
then a final twist-balancing step.

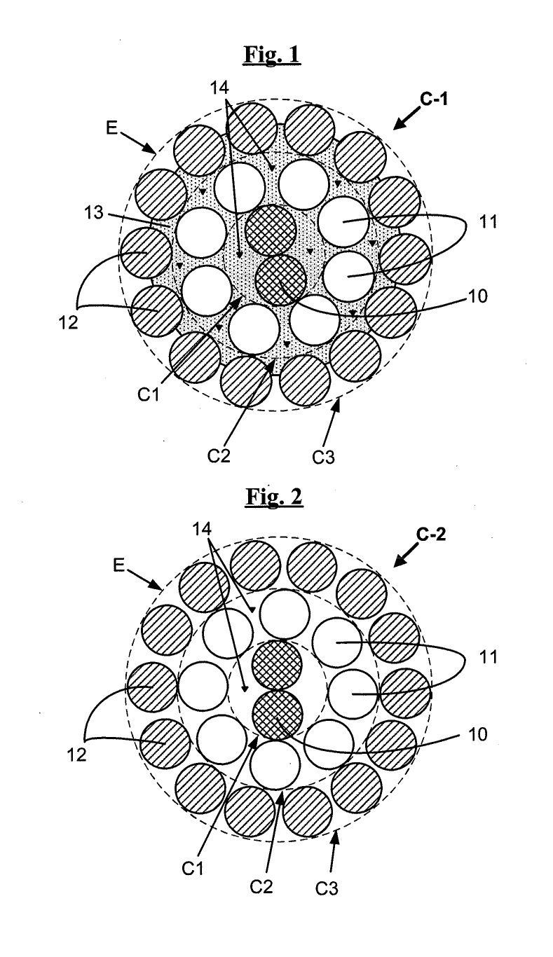

The invention and its advantages will be readily understood in the light of the following description and embodiments, and from FIGS. 1 to 4 which relate to these embodiments and which respectively diagrammatically depict:

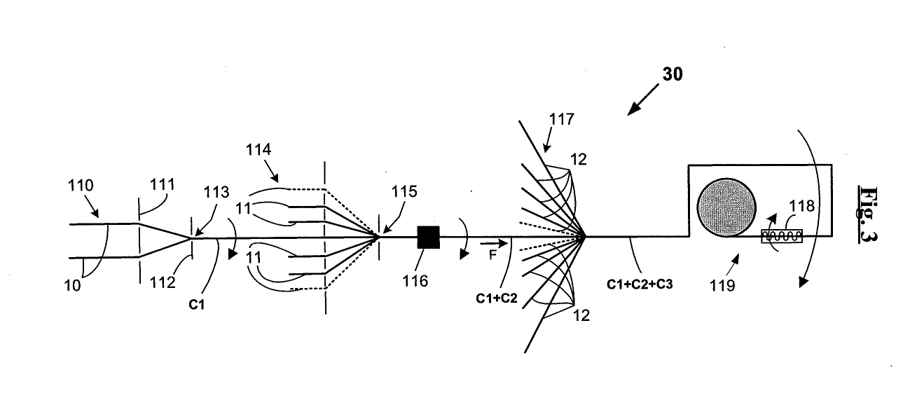

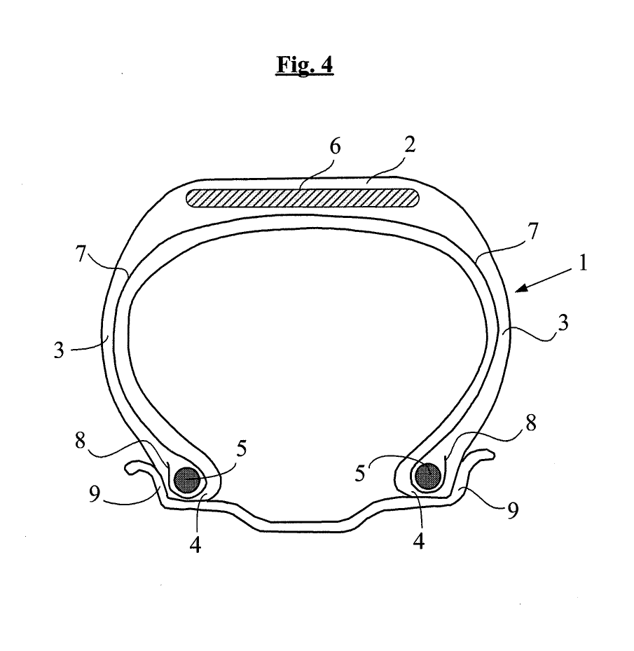

in cross section, a cord of 2+8+14 construction according to the invention, rubberized in situ, and of the type having cylindrical layers (FIG. 1);
in cross section, a conventional cord of 2+8+14 construction, not rubberized in situ, but likewise of the type having cylindrical layers (FIG. 2);
an example of an in situ rubberizing and twisting installation that can be used for manufacturing cords according to the invention (FIG. 3);
in radial section, a heavy goods vehicle tire casing with radial carcass reinforcement, which may or may not in this generalized depiction be according to the invention (FIG. 4).

### I. MEASUREMENTS AND TESTS

### I-1. Dynamometric Measurements

As regards the metal wires and cords, measurements of the breaking strength denoted Fm (maximum load in N), tensile strength denoted Rm (in MPa) and elongation at break, denoted At (total elongation in %) are carried out in tension in accordance with standard ISO 6892 of 1984.

As regards the diene rubber compositions, the modulus measurements are carried out under tension, unless otherwise indicated, in accordance with standard ASTM D 412 of 1998 (specimen “C”): the “true” secant modulus (i.e. the modulus with respect to the actual cross section of the specimen) at 10% elongation, denoted E10 and expressed in MPa, is measured on second elongation (that is to say, after one accommodation cycle) (normal temperature and moisture conditions in accordance with standard ASTM D 1349 of 1999).

### I-2. Air Permeability Test

This test enables the longitudinal air permeability of the tested cords to be determined by measuring the volume of air passing through a specimen under constant pressure over a given time. The principle of such a test, well known to those skilled in the art, is to demonstrate the effectiveness of the treatment of a cord in order to make it impermeable to air. The test is described, for example, in standard ASTM D2692-98.

The test is carried out here either on cords extracted from tires or from the rubber plies that they reinforce, which have therefore already been coated from the outside with cured rubber, or on as-manufactured cords which have been subsequently coated and cured.

In the latter instance, the as-manufactured cords have, prior to the test, to be coated from the outside by a rubber known as a coating rubber. To do this, a series of ten cords arranged parallel to one another (with an inter-cord distance of 20 mm) is placed between two skims (two rectangles measuring 80×200 mm) of an uncured rubber composition, each skim having a thickness of 3.5 mm; the whole assembly is then clamped in a mould, each of the cords being kept under sufficient tension (for example 2 daN) to ensure that it remains straight while being placed in the mould, using clamping modules; the vulcanizing (curing) process then takes place over 40 minutes at a temperature of 140° C. and under a pressure of 15 bar (applied by a rectangular piston measuring 80×200 mm). After that, the assembly is demoulded and cut up into 10 specimens of cords thus coated, in the form of parallelepipeds of appropriate dimensions (e.g. 7×7×20 or 7×7×30 mm), for characterization.

A conventional tire rubber composition is used as coating rubber, the said composition being based on natural (peptized) rubber and N330 carbon black (60 phr), also containing the following usual additives: sulphur (7 phr), sulfenamide accelerator (1 phr), ZnO (8 phr), stearic acid (0.7 phr), antioxidant (1.5 phr) and cobalt naphthenate (1.5 phr) (phr signifying parts by weight per hundred parts of rubber); the modulus E10 of the coating rubber is about 10 MPa.

The test is carried out on a predetermined (e.g. 3 cm or even 2 cm) length of cord, hence coated with its surrounding rubber composition (or coating rubber) in the cured state, as follows: air under a pressure of 1 bar is injected into the inlet of the cord and the volume of air leaving it is measured using a flow meter (calibrated for example from 0 to 500 cm³/min). During measurement, the cord specimen is immobilized in a compressed airtight seal (for example a dense foam or rubber seal) so that only the quantity of air passing through the cord from one end to the other along its longitudinal axis is measured; the airtightness of the airtight seal is checked beforehand using a solid rubber specimen, that is to say one containing no cord.

The higher the longitudinal impermeability of the cord, the lower the measured mean air flow rate (averages over 10 specimens). Since the measurement is accurate to ±0.2 cm³/min, measured values equal to or lower than 0.2 cm³/min are considered to be zero; they correspond to a cord that can be termed airtight (completely airtight) along its axis (i.e. in its longitudinal direction).

### I-3. Filling Rubber Content

The amount of filling rubber is measured by measuring the difference between the weight of the initial cord (therefore the in-situ rubberized cord) and the weight of the cord (and therefore that of its wires) from which the filling rubber has been removed using an appropriate electrolytic treatment.

A cord specimen (1 m in length), coiled on itself to reduce its size, constitutes the cathode of an electrolyser (connected to the negative terminal of a generator) while the anode (connected to the positive terminal) consists of a platinum wire. The electrolyte consists of an aqueous (demineralised water) solution containing 1 mol per litre of sodium carbonate.

The specimen, completely immersed in the electrolyte, has voltage applied to it for 15 minutes with a current of 300 mA. The cord is then removed from the bath and abundantly rinsed with water. This treatment enables the rubber to be easily detached from the cord (if this is not so, the electrolysis is continued for a few minutes). The rubber is carefully removed, for example by simply wiping it using an absorbent cloth, while untwisting the wires one by one from the cord. The wires are once again rinsed with water and then immersed in a beaker containing a mixture of demineralised water (50%) and ethanol (50%); the beaker is immersed in an ultrasonic bath for 10 minutes. The wires thus stripped of all traces of rubber are removed from the beaker, dried in a stream of nitrogen or air, and finally weighed.

From this is deduced, by calculation, the filling rubber content of the cord, expressed in mg (milligrams) of filling rubber per g (gram) of initial cord averaged over 10 measurements (i.e. over 10 metres of cord in total).

### II. DETAILED DESCRIPTION OF THE INVENTION

In the present description, unless expressly indicated otherwise, all the percentages (%) indicated are percentages by weight.

Moreover, any range of values denoted by the expression “between a and b” represents the range of values extending from more than a to less than b (i.e. excluding the end points a and b), whereas any range of values denoted by the expression “from a to b” means the range of values extending from a to b (i.e. including the strict end points a and b).

### II-1. Cord of the Invention

The metal cord of the invention therefore comprises three concentric layers:
a first layer or central layer (C1) consisting of 2 wires of diameter d₁, assembled in a helix at a pitch p₁;
a second layer (C2) comprising M wires of diameter d₂, assembled in a helix at a pitch p₂ around the first layer;
a third layer (C3) comprising N wires of diameter of diameter d₃, assembled in a helix at a pitch p₃ around the second layer.

In a known way, the first and second assembled layers (C1+C2) constitute what is commonly called the centre of the cord, supporting the outermost layer (C3).

This cord of the invention also has the following characteristics (d₁, d₂, d₃, p₁, p₂ and p₃ being expressed in mm):
0.08≦d₁≦0.50;
0.08≦d₂≦0.50;
0.08≦d₃≦0.50;
3<p₁<50;
6<p₂<50;
9<p₃<50;
over any 3 cm length of cord, a rubber composition called “filling rubber” is present in each of the capillaries delimited by on the one hand the 2 wires of the first layer (C1) and the M wires of the second layer (C2), and on the other hand by the M wires of the second layer (C2) and the N wires of the third layer (C3);
the content of filling rubber in the cord is comprised between 10 and 50 mg per gram of cord.

This cord of the invention can be termed an in-situ-rubberized cord, i.e. it is rubberized from the inside, during its actual manufacture (and therefore in the as-manufactured state) with filling rubber. In other words, each of the capillaries or gaps (the two interchangeable terms denoting voids or spaces that in the absence of filling rubber are empty) situated between, delimited by, both the two wires of the first layer (C1) and the M wires of the second layer (C2), and both the M wires of the second layer (C2) and the N wires of the third layer (C3) is at least partially, continuously or otherwise along the axis of the cord, filled with the filling rubber.

According to a preferred embodiment, over any 3 cm length, or more preferably any 2 cm length, of cord, each capillary or gap described hereinabove comprises at least one plug of rubber; in other words and for preference, there is at least one plug of rubber every 3 cm, or preferably every 2 cm, of cord, which blocks each capillary or gap of the cord in such a way that, in the air permeability test (in accordance with paragraph I-2), this cord of the invention has an average air flow rate of less than 2 cm³/min, more preferably of less than 0.2 cm³/min or at most equal to 0.2 cm³/min.

The other essential feature of the cord of the invention is that its filling rubber content is comprised between 10 and 50 mg of rubber per g of cord. Below the indicated minimum, it is not possible to guarantee that, over any 3 cm, preferably 2 cm length of cord, the filling rubber will be correctly present, at least in part, in each of the gaps or capillaries of the cord to form preferably at least one plug, whereas above the indicated maximum, the cord is exposed to the various problems described hereinabove which are due to the overspilling of filling rubber at the periphery of the cord. For all of these reasons, it is preferable for the filling rubber content to be comprised between 15 and 45 mg, more preferably between 15 and 40 mg of filling rubber, per g of cord.

Such a filling rubber content and keeping it within the above defined limits is made possible only by the use of a special twisting-rubberizing process suited to the geometry of the cord, and which will be explained in detail later.

Use of this specific process, while at the same time making it possible to obtain a cord in which the quantity of filling rubber is controlled, guarantees that internal partitions (which are continuous or discontinuous along the axis of the cord) or plugs of rubber will be present in the capillaries of the cord of the invention, and will be so in sufficient number; thus, the cord of the invention becomes impervious to the spread, along the cord, of any corrosive fluid such as water or the oxygen in the air, thus eliminating the wicking effect described in the introduction of this text.

Thus, the following feature is preferably satisfied: over any 3 cm, preferably 2 cm length of cord, the cord is airtight or virtually airtight in the longitudinal direction. In other words, each capillary comprises at least one plug (or internal partition) of filling rubber over this given length so that the said cord (once coated from the outside with a polymer such as rubber) is airtight or virtually airtight in its longitudinal direction.

In the air permeability test described in paragraph I-2, a cord said to be “airtight” in the longitudinal direction is characterized by a mean air flow rate less than or at most equal to 0.2 cm³/min whereas a cord said to be “virtually airtight” in the longitudinal direction is characterized by a mean air flow rate of less than 2 cm³/min, preferably of less than 1 cm³/min.

For an optimized compromise between strength, feasibility, rigidity and flexural durability of the cord, it is preferable for the diameters of the wires in the layers C1, C2 and C3, whether or not these wires have the same diameter from one layer to the next, to satisfy the following relationships (d₁, d₂, d₃ being expressed in mm):
0.10≦d₁≦0.40;
0.10≦d₂≦0.40;
0.10≦d₃≦0.40.

More preferably still, the following relationships are satisfied:
0.10≦d₁≦0.30;
0.10≦d₂≦0.30;
0.10≦d₃≦0.30.

The wires in layers C1, C2 and C3 may have the same diameter or different diameters from one layer to the next; use is preferably made of wires of the same diameter from one layer to the next (namely d₁=d₂=d₃), as this notably simplifies manufacture and reduces the cost of the cords.

The pitches p₂ and p₃ are more preferably chosen in a range from 8 to 25 mm, more preferably still in a range from 10 to 20 mm, particularly when d₂=d₃.

According to another preferred embodiment, p₂ and p₃ are equal, it being possible for the pitch p₁ to be the same as or different from p₂. According to other possible embodiments, p₁=p₂≠p₃ or alternatively p₁≠p₂≠p₃.

According to another preferred embodiment, for a better compromise between cord strength and flexibility, the following characteristics are satisfied;
3<p₁<30;
6<p₂<30;
9<p₃<30.

It will be recalled here that, as is known, the pitch “p” represents the length, measured parallel to the axis of the cord, at the end of which a wire of this pitch has made a complete turn around the said axis of the cord.

According to another particular embodiment, the three pitches p₁, p₂ and p₃ are not identical. This is notably the case for example of cords having layers of the cylindrical type like those depicted schematically for example in FIG. 1, in which the three layers C1, C2 and C3 preferably have the additional feature of being wound in the same direction of twisting (S/S/S or Z/Z/Z).

In such cords having cylindrical layers, as is known, the compactness is such that the cross section of such cords has a contour which is cylindrical rather than polygonal, as illustrated by way of example in FIG. 1 (cord having cylindrical layers 2+8+14 according to the invention) or in FIG. 2 (control cord having cylindrical layers 2+8+14, i.e. one that has not been rubberized in situ).

The third layer or outer layer C3 has the preferred feature of being a saturated layer, i.e. by definition, there is not enough space in this layer for at least one (Nₘₐₓ+1)th wire of diameter d₃ to be added, Nₘₐₓ representing the maximum number of wires that can be wound in a layer around the second layer C2. This construction has the notable advantage of further limiting the risk of overspill of filling rubber at its periphery and, for a given cord diameter, of offering greater strength.

However, the invention also applies to cases in which the outer layer (C3) is an unsaturated layer.

Thus, the number N of wires can vary to a very large extent according to the particular embodiment of the invention, it being understood that the maximum number Nₘₐₓ of wires N will be increased if their diameter d₃ is reduced by comparison with the diameter d₂ of the wires of the second layer, in order preferably to keep the outer layer in a saturated state.

According to a preferred embodiment, the second layer (C2) contains from 6 to 10 wires and the third layer (C3) contains from 12 to 16 wires; of the abovementioned cords those more particularly selected are those consisting of wires that have an identical diameter from layer C2 to layer C3 (namely d₂=d₃).

According to a more particularly preferred embodiment, the second layer (C2) contains 7 or 8 wires (i.e. M equals 7 or 8) and the third layer (C3) contains 13 or 14 wires (i.e. N equals 13 or 14). The cord of the invention has the particularly preferential constructions 2+7+13 and 2+8+14.

The cord of the invention, like any layered cord, may be of two types, namely of the compact type or of the cylindrical layers type.

For preference, the three layers C1, C2 and C3 are wound in the same direction of twisting, i.e. either in the S direction (“S/S/S” arrangement), or in the Z direction (“Z/Z/Z” arrangement). Winding these layers in the same direction advantageously minimizes friction between these two layers and therefore wear on the wires of which they are composed.

More preferably, they are wound in the same direction of twisting and at a pitch p₁ different from p₂ and/or p₃, whether p₂ and p₃ are identical or different, in order to obtain a cord of the cylindrical layers type like the one depicted for example in FIG. 1.

The construction of the cord of the invention advantageously allows the wrapping wire to be omitted because the rubber better penetrates its structure and gives a self-wrapping effect.

The term “metal cord” is understood by definition in the present application to mean a cord formed from wires consisting predominantly (i.e. more than 50% by number of these wires) or entirely (100% of the wires) of metallic material.

Independently of one another, and from one layer to another, the wire or wires of the central layer (C1), the wires of the second layer (C2) and the wires of the third layer (C3) are preferably made of steel, more preferably of carbon steel. However, it is of course possible to use other steels, for example a stainless steel, or other alloys.

When a carbon steel is used, its carbon content (% by weight of steel) is preferably comprised between 0.4% and 1.2%, notably between 0.5% and 1.1%; these contents represent a good compromise between the mechanical properties required for the tire and the feasibility of the wires. It should be noted that a carbon content comprised between 0.5% and 0.6% ultimately makes such steels less expensive because they are easier to draw. Another advantageous embodiment of the invention may also consist, depending on the intended applications, in using steels with a low carbon content, comprised for example between 0.2% and 0.5%, particularly because of a lower cost and greater drawability.

The metal or the steel used, whether in particular this is a carbon steel or a stainless steel, may itself be coated with a metal layer which, for example, improves the workability of the metal cord and/or of its constituent elements, or the use properties of the cord and/or of the tire themselves, such as properties of adhesion, corrosion resistance or resistance to ageing. According to one preferred embodiment, the steel used is covered with a layer of brass (Zn—Cu alloy) or of zinc; it will be recalled that, during the wire manufacturing process, the brass or zinc coating makes the wire easier to draw, and makes the wire adhere to the rubber better. However, the wires could be covered with a thin layer of metal other than brass or zinc, having, for example, the function of improving the corrosion resistance of these wires and/or their adhesion to the rubber, for example a thin layer of Co, Ni, Al, an alloy of two or more of the compounds Cu, Zn, Al, Ni, Co, Sn.

The cords of the invention are preferably made of carbon steel and have a tensile strength (Rm) preferably higher than 2500 MPa, more preferably higher than 3000 MPa. The total elongation at break (At) of the cord, which is the sum of its structural, elastic and plastic elongations, is preferably greater than 2.0%, and more preferably still at least equal to 2.5%.

The elastomer (or indiscriminately “rubber”, the two being considered as synonymous) of the filling rubber is preferably a diene elastomer, i.e. by definition an elastomer originating at least in part (i.e. a homopolymer or copolymer) from diene monomer(s) (i.e. monomer(s) bearing two, conjugated or otherwise, carbon-carbon double bonds). The diene elastomer is more preferably chosen from the group consisting of polybutadienes (BR), natural rubber (NR), synthetic polyisoprenes (IR), various copolymers of butadiene, various copolymers of isoprene, and blends of these elastomers. Such copolymers are more preferably chosen from the group consisting of butadiene-stirene copolymers (SBR), whether these are prepared by emulsion polymerization (ESBR) or solution polymerization (SSBR), butadiene-isoprene copolymers (BIR), stirene-isoprene copolymers (SIR) and stirene-butadiene-isoprene copolymers (SBIR).

One preferred embodiment is to use an “isoprene” elastomer, i.e. a homopolymer or copolymer of isoprene, in other words a diene elastomer chosen from the group consisting of natural rubber (NR), synthetic polyisoprenes (IR), various isoprene copolymers and blends of these elastomers. The isoprene elastomer is preferably natural rubber or a synthetic polyisoprene of the cis-1,4 type. Of these synthetic polyisoprenes, use is preferably made of polyisoprenes having a content (in mol %) of cis-1,4 bonds greater than 90%, more preferably still greater than 98%. According to other preferred embodiments, the isoprene elastomer may also be combined with another diene elastomer, such as one of the SBR and/or BR type, for example.

The filling rubber may contain just one elastomer or several elastomers, notably of the diene type, it being possible for this or these to be used in combination with any type of polymer other than an elastomer.

The filling rubber is preferably of the crosslinkable type, i.e. it by definition contains a crosslinking system suitable for allowing the composition to crosslink during its curing process (i.e. so that, when it is heated, it hardens rather than melts); thus, in such an instance, this rubber composition may be qualified as unmeltable, because it cannot be melted by heating, whatever the temperature. For preference, in the case of a diene rubber composition, the crosslinking system for the rubber sheath is a system known as a vulcanizing system, i.e. one based on sulphur (or on a sulphur donor agent) and at least one vulcanization accelerator. Various known vulcanization activators may be added to this vulcanizing system. Sulphur is used at a preferred content of between 0.5 and 10 phr, more preferably between 1 and 8 phr. The vulcanization accelerator, for example a sulphenamide, is used at a preferred content of between 0.5 and 10 phr, more preferably between 0.5 and 5.0 phr.

The filling rubber may also contain, in addition to said crosslinking system, all or some of the additives customarily used in the rubber matrixes intended for the manufacture of tires, such as reinforcing fillers such as carbon black or inorganic fillers such as silica, coupling agents, anti-ageing agents, antioxidants, plasticising agents or oil extenders, whether these be of an aromatic or non-aromatic type, especially very weakly or non-aromatic oils, for example of the naphthenic or paraffinic type, with a high or preferably a low viscosity, MES or TDAE oils, plasticizing resins having a high Tg above 30° C., processing aids for making it easier to process the compositions in the uncured state, tackifying resins, anti-reversion agents, methylene acceptors and donors, such as for example HMT (hexamethylene tetramine) or H3M (hexamethoxymethylmelamine), reinforcing resins (such as resorcinol or bismaleimide), known adhesion promoter systems of the metal salt type for example, notably cobalt or nickel salts.

The content of reinforcing filler, for example carbon black or an inorganic reinforcing filler such as silica, is preferably greater than 50 phr, for example comprised between 50 and 120 phr. As carbon blacks, for example, all carbon blacks, particularly of the HAF, ISAF, SAF type conventionally used in tires (known as tire-grade blacks), are suitable. Of these, mention may more particularly be made of carbon blacks of (ASTM) 300, 600 or 700 grade (for example N326, N330, N347, N375, N683, N772). Suitable inorganic reinforcing fillers notably include inorganic fillers of the silica (SiO₂) type, especially precipitated or pyrogenic silicas having a BET surface area of less than 450 m²/g, preferably from 30 to 400 m²/g.

The person skilled in the art will know, in the light of the present description, how to adjust the formulation of the filling rubber in order to achieve the levels of properties (particularly elastic modulus) desired, and how to adapt the formulation to suit the intended specific application.

In a first embodiment of the invention, the formulation of the filling rubber can be chosen to be identical to the formulation of the rubber matrix that the cord of the invention is intended to reinforce; there will therefore be no problem of compatibility between the respective materials of the filling rubber and of the said rubber matrix.

According to a second embodiment of the invention, the formulation of the filling rubber may be chosen to differ from the formulation of the rubber matrix that the cord of the invention is intended to reinforce. Notably, the formulation of the filling rubber can be adjusted by using a relatively high quantity of adhesion promoter, typically for example from 5 to 15 phr of a metallic salt such as a cobalt or nickel salt, and advantageously reducing the quantity of the said promoter (or even omitting it altogether) in the surrounding rubber matrix. Of course, it might also be possible to adjust the formulation of the filling rubber in order to optimize its viscosity and thus its ability to penetrate the cord when the latter is being manufactured.

For preference, the filling rubber, in the crosslinked state, has a secant modulus in extension E10 (at 10% elongation) which is comprised between 2 and 25 MPa, more preferably between 3 and 20 MPa, and in particular comprised in a range from 3 to 15 MPa.

The invention of course relates to the abovementioned cord both in the uncured state (with its filling rubber then not crosslinked) and in the cured state (with its filling rubber then crosslinked or vulcanized). However, it is preferable for the cord of the invention to be used with a filling rubber in the uncured state until it is subsequently incorporated into the semi-finished product or finished product such as tire for which it is intended, so as to encourage bonding, during final crosslinking or vulcanizing, between the filling rubber and the surrounding rubber matrix (for example the calendering rubber).

FIG. 1 schematically depicts, in cross section perpendicular to the axis of the cord (which is assumed to be straight and at rest), one example of a preferred 2+8+14 cord according to the invention.

This cord (denoted C-1) is of the cylindrical layers type, that is to say that its first, second and third layers (C1, C2 and C3 respectively) are wound either at different pitches or in different directions of twisting. This type of construction has the effect that the wires (11, 12 respectively) of its second and third layers (C2, C3) form, around the two wires (10) of the first layer (C1), two substantially cylindrical layers which each have a contour (E) (depicted in dotted line) which is substantially cylindrical rather than polygonal (more specifically hexagonal) as in the case of cords of the so-called compact layer type.

It may be seen from this FIG. 1 that the filling rubber (13), while parting the wires very slightly, at least partially fills each of the capillaries or gaps (14) (by way of example, some of them are symbolized here by a triangle) which are delimited on the one hand by the two wires (10) of the first layer (C1) and the M wires (11) of the second layer (C2), and on the other hand by the M wires (11) of the second layer (C2) and the N wires (12) of the third layer (C3), the wires being considered in groups of at least 3 adjacent wires (3, 4, 5 or even 6 in this instance, according to the examples of capillaries or gaps depicted in FIG. 1).

According to a preferred embodiment, in the cord according to the invention, the filling rubber extends continuously around the second layer (C2) which it covers.

For comparison, FIG. 2 provides a reminder, in cross section, of a conventional 2+8+14 cord (denoted C-2, (i.e. that has not been rubberized in situ), having three layers (C1, C2 and C3), likewise of the cylindrical layers type (cylindrical contour E). The characteristic of this type of cord is that its various wires (10, 11, 12) form numerous channels or capillaries (14) which remain closed and empty and are therefore propicious, through the “wicking” effect, to the propagation of corrosive media such as water.

The cord of the invention could be provided with an external wrapper, consisting for example of a single metal or non-metal thread wound in a helix around the cord at a pitch that is shorter than that of the outer layer (C3) and in a direction of winding that is the opposite of or the same as that of this outer layer. However, because of its special structure, the cord of the invention, which is already self-wrapped, does not generally require the use of an outer wrapping thread, and this advantageously solves the problems of wear between the wrapper and the wires of the outermost layer of the cord.

However, if a wrapping thread is used, in the general case where the wires of the outer layer are made of carbon steel, a wrapping thread made of stainless steel can then advantageously be chosen in order to reduce fretting wear of these carbon steel wires upon contact with the stainless steel wrapper, as taught, for example, in application WO-A-98/41682, the stainless steel wire potentially being replaced, like for like, by a composite thread only the skin of which is made of stainless steel with the core being made of carbon steel, as described for example in document EP-A-976 541. It is also possible to use a wrapper made of polyester or a thermotropic aromatic polyester-amide as described in application WO-A-03/048447.

The person skilled in the art will understand that the cord of the invention as described hereinabove could potentially be rubberized in situ with a filling rubber based on elastomers other than diene elastomers, notably with thermoplastic elastomers (TPE) such as polyurethane elastomers (TPU) for example which as is known do not require crosslinking or vulcanizing but which, at the service temperature, exhibit properties similar to those of a vulcanized diene elastomer.

However, and as a particular preference, the present invention is implemented using a filling rubber based on diene elastomers as previously described, notably by use of a special manufacturing process which is particularly well suited to such elastomers. This manufacturing process is described in detail hereinafter.

### II-2. Manufacture of the Cord of the Invention

The abovementioned cord of the invention, preferably rubberized in situ using a diene elastomer, can be manufactured using a process involving preferably the following steps more preferably performed in line and continuously:
a first step of assembling by twisting the two wires of the central layer to form, at a first point called “first assembling point” the first layer or central layer (C1);
a second assembling step by twisting the M wires around the central layer (C1) to form, at a second point called “second assembling point” an intermediate cord (C1+C2) called “core strand” of 2+M construction;
downstream of the first assembling point, a sheathing step in which the central layer (C1) and/or the core strand (C1+C2) is/are sheathed with filling rubber in the uncured state, this sheathing being conducted either upstream or downstream or both upstream and downstream of the second assembling point;
followed by a third assembling step by twisting or cabling the N wires around the core strand thus sheathed;
then a final twist-balancing step.

For preference, the step of sheathing with the filling rubber is performed on the central layer (C1) alone, downstream of the first assembling point and upstream of the second assembling point, the filling rubber being delivered in a single shot in sufficient quantity to obtain the cord according to the invention. One possible alternative form of embodiment might be to perform, downstream of the second assembling point, an additional step of sheathing the core strand (C1+C2). However, it is preferable to use just one sheathing step.

It will be recalled here that there are two possible techniques for assembling metal wires:
either by cabling: in which case the wires undergo no twisting about their own axis, because of a synchronous rotation before and after the assembling point;
or by twisting: in which case the wires undergo both a collective twist and an individual twist about their own axis, thereby generating an untwisting torque on each of the wires and on the cord itself.

One essential feature of the above method is the use of a twisting step both for assembling the wires of the first layer (C1) and for assembling the second layer (C2) around the central layer (C1).

The third layer (C3) can be assembled around the second layer (C2) by twisting or by cabling. It is preferable to use a twisting operation as for the first two assembling operations (layers C1 and C2).

If the third layer (C3) is assembled by cabling, the cord is then preferably manufactured in two discontinuous steps (the twisting of the first two layers then the subsequent cabling of the third layer); in this case it is preferable to use two sheathing steps, a first sheathing of the central layer (C1) and a later second sheathing on the core strand (C1+C2).

By way of example, the procedure is as follows.

During the first step, the 2 wires of the central layer are twisted together (S or Z direction) to form the first layer (C1) in a way known per se; the wires are delivered by feed means such as spools, a separating grid, which may or may not be coupled to an assembling guide, intended to make the 2 wires converge on a common twisting point (or first assembling point).

At the end of the preceding step, the M wires of the second layer (C2) are twisted together (S direction or Z direction) around the central layer (C1) to form the core strand (C1+C2); as before for the wires of the central layer, the wires of the second layer are delivered by feed means such as spools, a separating grid, intended to make the M wires converge around the central layer on a common twisting point (or second assembling point).

The core (C1+C2) thus formed is then sheathed with uncured filling rubber supplied by an extrusion screw at an appropriate temperature. The filling rubber can thus be delivered at a single and small-volume fixed point by means of a single extrusion head.

The extrusion head may comprise one or more dies, for example an upstream guiding die and a downstream sizing die. Means for continuously measuring and controlling the diameter of the cord may be added, these being connected to the extruder. For preference, the temperature at which the filling rubber is extruded is comprised between 50° C. and 120° C., and more preferably is comprised between 50° C. and 100° C.

The extrusion head thus defines a sheathing zone having, for example in the preferred case in which there is just one sheathing step performed on the central layer (C1), the shape of a cylinder of revolution, the diameter of which is preferably comprised between 0.15 mm and 1.2 mm, more preferably between 0.2 and 1.0 mm, and the length of which is preferably comprised between 4 and 10 mm.

The amount of filling rubber delivered by the extrusion head can easily be adjusted so that, in the final cord, this quantity is comprised between 10 and 50 mg per g of final, i.e. finished as-manufactured rubberized in situ, cord.

Below the indicated minimum, it is not possible to guarantee that the filling rubber will be correctly present in each of the capillaries or gaps of the cord, whereas above the indicated maximum, the cord is exposed to the various problems described hereinabove which are due to the overspilling of filling rubber at the periphery of the cord, according to the particular implementation conditions of the invention, and the specific construction of the manufactured cords. For all of these reasons, it is preferable for the quantity of filling rubber delivered to be comprised between 15 and 45 mg, more preferably between 15 and 40 mg per g of cord.

Downstream of the second assembling point, the tensile strength applied to the core strand is preferably comprised between 10 and 25% of its breaking strength.

In the preferred case of a single sheathing step performed on the central layer (C1), the central layer of the cord, as it leaves the extrusion head, is, at all points on its periphery, preferably covered with a minimum thickness of filling rubber which exceeds 20 μm, more preferably exceeds 30 μm, and is notably comprised between 30 and 80 μm.

During a third step, final assembly is performed, again by twisting (S direction or Z direction) the N wires of the third layer or outer layer (C3) around the core strand (C1+C2) thus sheathed.

At this stage in the process, the cord of the invention is not yet finished: the capillaries or channels delimited by the M wires of the second layer (C2) and the N wires of the third layer (C3) are not yet full of filling rubber, or in any event are not yet full enough to yield a cord of optimal air impermeability.

The important step which follows involves passing the cord thus provided with its filling rubber in the uncured state, through twist-balancing means in order to obtain a cord said to be twist-balanced (i.e. practically without residual torsion); what is meant here by “twist balancing” is, in the known way, the cancelling out of residual twisting torques (or untwisting spring back) exerted on each wire of the cord in the twisted state, within its respective layer. Twist-balancing tools are known to those skilled in the art of twisting; they may for example consist of straighteners and/or of twisters and/or of twister-straighteners consisting either of pulleys in the case of twisters, or of small-diameter rollers in the case of straighteners, through which pulleys or rollers the cord runs, in a single plane, or preferably in at least two different planes.

It is assumed a posteriori that, during the passage through the various balancing tools described hereinabove, the latter generate, on the M and N wires of the second and third layers (C2 and C3) a torsion and a radial pressure which are sufficient to redistribute the still-hot and relatively fluid filling rubber in the raw (i.e. uncrosslinked, uncured) state, transferring it in part from the capillaries formed by the central layer (C1) and the M wires of the second layer (C2) towards the inside of the capillaries formed by the M wires of the second layer (C2) and the N wires of the third layer (C3), ultimately giving the cord of the invention the excellent air impermeability property that characterizes it. The straightening function afforded by the use of a straightening tool would also have the advantage that contact between the rollers of the straightener and the wires of the outer layer (C3) will apply additional radial pressure to the filling rubber, further encouraging it to penetrate fully the capillaries present between the second layer (C2) and the third layer (C3) of the cord.

In other words, the process described hereinabove uses the twist of the wires and the radial pressure exerted on the wires in the final stage of manufacture of the cord to distribute the filling rubber radically inside the cord, while at the same time perfectly controlling the amount of filling rubber supplied. The person skilled in the art will notably know how to adjust the arrangement and diameter of the pulleys and/or rollers of the twist-balancing means in order to alter the intensity of the radial pressure applied to the various wires.

Thus, unexpectedly, it has proved possible to make the filling rubber penetrate into the very heart of the cord of the invention and into all of its capillaries, by depositing the rubber downstream of the first point of assembly of the 2 wires for the formation of the first layer or central layer (C1), while at the same time still controlling and optimizing the amount of filling rubber delivered, thanks to the use of a single extrusion head.

After this final twist-balancing step, the manufacture of the cord of the invention, rubberized in situ with its filling rubber in the uncured state, is complete.

For preference, in this completed cord, the thickness of filling rubber between two adjacent wires of the cord, whichever these wires might be (in particular between 2 wires of the central layer C1), is greater than 1 μm, preferably comprised between 1 and 10 μm. This cord can be wound onto a receiving spool, for storage, before for example being treated via a calendering installation, in order to prepare a metal/rubber composite fabric that can be used for example as a tire carcass reinforcement, or alternatively can be assembled into a multistrand rope.

Another form of embodiment of the method of manufacture that has just been described may consist in performing the sheathing step on the central layer (C1) itself, i.e. upstream rather than downstream of the second assembly point. The filling rubber in the raw state is then delivered in a single shot, in sufficient quantity to allow acord according to the invention to be obtained.

Another alternative form of embodiment may also consist in performing two successive sheathing steps, the first on the central layer (C1) and the second on the core strand (C1+C2), the filling rubber in the raw state then being delivered in two distinct steps, in appropriate respective quantities. However, it is preferable to use just one sheathing step, preferably that of sheathing the core stand (C1+C2).

The method described above has the advantage of making it possible for the complete operation of twisting and rubberizing to be performed in line and continuously, regardless of the type of cord manufactured (cord with cylindrical layers or compact cord), and to do all this at high speed. The above method can be implemented at a speed (the speed at which the cord travels along the twisting-rubberizing line) in excess of 50 m/min, preferably in excess of 70 m/min, notably in excess of 100 m/min.

This method of course applies to the manufacture of cords of compact type (as a reminder and by definition, those in which the layers C1, C2 and C3 are wound at the same pitch and in the same direction) and to the manufacture of cords of the cylindrical layers type (as a reminder and by definition, those in which the layers C1, C2 and C3 are wound either at different pitches (whatever their direction of twisting, identical or otherwise) or in opposite directions (whatever their pitches, identical or different)).

The method described above makes it possible, according to a particularly preferred embodiment, to manufacture cords which may have no (or virtually no) filling rubber at their periphery. What is meant by that is that no particle of filling rubber is visible, to the naked eye, on the periphery of the cord, that is to say that a person skilled in the art would, after manufacture, see no difference, to the naked eye, from a distance of three metres or more, between a spool of cord in accordance with the invention and a spool of conventional cord that has not been rubberized in situ.

A rubberizing and assembling device that can preferably be used for implementing this method is a device comprising, from upstream to downstream in the direction of travel of a cord as it is being formed:
feed means and first assembling means which by twisting assemble the two central wires to form the first layer (C1) at a point called the first assembling point;
feed means and second assembling means which by twisting assemble the M wires of the second layer (C2) around the central layer (C1) at a point called the second assembling point, to form an intermediate cord called “core strand” of C1+C2 construction;
means of sheathing the central layer (C1) and/or the core strand (C1+C2), which are located either upstream or downstream or both upstream and downstream of the second assembling point;
feed means and third assembling means which by twisting assemble the N wires around the core strand, in order to apply the third layer (C3);
at the exit from the third assembling means, twist-balancing means.

The attached FIG. 3 shows an example of a twisting assembling device (30) that can be used for the manufacture of a three-layered cord of 2+M+N construction of the cylindrical layers type as illustrated for example in FIG. 1 discussed earlier.

In this device (30), feed means (110) initially deliver two wires (10) through a separating grid (111) (with axisymetric separation), which may or may not be coupled to an assembling guide (112), beyond which the two wires (10) converge at a first assembling point (113) to form the first layer or central layer (C1).

Feed means (114) then deliver, around the central layer (C1), M wires (11), for example through a separating grid coupled to an assembling guide, beyond which the M (for example 8) wires of the second layer converge at a second assembling point (115) to form the core strand (C1+C2) of 2+M (for example 2+8) construction.

The core strand (C1+C2) thus formed then passes through a sheathing zone (116) consisting for example of an extrusion head. The distance between the sheathing point (116) and the second point of convergence (115) is for example comprised between 1 and 5 metres.

The N wires (12) of the outer layer (C3), of which there are for example 14, delivered by feed means (117), are then assembled by twisting around the core strand (C1+C2) thus sheathed progressing in the direction of the arrow F. The final cord (C1+C2+C3) is finally collected on the rotary receiver (119) after having passed through the twist-balancing means (118) which, for example, consist of a straightener or of a twister-straightener.

It will be recalled here that, as is well known to those skilled in the art, in order to manufacture a cord of the cylindrical layers type as shown for example in FIG. 1, the device used must comprise at least two coupled rotating (feed or receiver) members rather than just the one as in the case of a cord with layers of the compact type.

### II-3. Use of the Cord in a Tire Carcass Reinforcement

As explained in the introduction to this text, the cord of the invention is particularly intended for a carcass reinforcement of a tire for an industrial vehicle.

By way of example, FIG. 4 very schematically depicts a radial section through a tire with metal carcass reinforcement that may or may not be one in accordance with the invention in this generalized depiction.

This tire 1 comprises a crown 2 reinforced by a crown reinforcement or belt 6, two sidewalls 3 and two beads 4, each of these beads 4 being reinforced with a bead wire 5. The crown 2 is surmounted by a tread which has not been depicted in this schematic figure. A carcass reinforcement 7 is wound around the two bead wires 5 in each bead 4, the turned-back portion 8 of this reinforcement 7 for example being positioned towards the outside of the tire 1 which here has been depicted mounted on its rim 9. The carcass reinforcement 7 is, in a way known per se, made up of at least one ply reinforced by metal cords known as “radial” cords, which means that these cords run practically parallel to one another and extend from one bead to the other so as to form an angle comprised between 80° and 90° with the circumferential median plane (a plane perpendicular to the axis of rotation of the tire which is situated midway between the two beads 4 and passes through the middle of the crown reinforcement 6).

The tire according to the invention is characterized in that its carcass reinforcement 7 comprises at least, by way of an element for reinforcing at least one carcass ply, a metal cord according to the invention. Of course, this tire 1 further comprises, in the known way, an interior layer of rubber or elastomer (commonly known as the “inner liner”) which defines the radially internal face of the tire and is intended to protect the carcass ply from diffusion of air coming from the space inside the tire.

For preference, the rubber composition used for the fabric of the carcass reinforcement ply has, in the vulcanized state (i.e. after curing), a secant modulus in extension E10 which is comprised between 2 and 25 MPa, more preferably between 3 and 20 MPa, and in particular comprised in a range from 3 to 15 MPa.

### III. EMBODIMENTS OF THE INVENTION

The following tests demonstrate that the three-layer cords in accordance with the invention, by comparison with the in-situ-rubberized three-layer cords of the prior art, have the appreciable advantage of containing a smaller quantity of filling rubber, guaranteeing them better compactness, this rubber also being distributed uniformly within the cord, inside each of its capillaries, thus giving them optimum longitudinal impermeability.

Layered cords of 2+8+14 construction, made up of fine brass-coated carbon-steel wires, were used in the tests.

The carbon steel wires were prepared in a known manner, for example from machine wire (diameter 5 to 6 mm) which was firstly work-hardened, by rolling and/or drawing, down to an intermediate diameter of around 1 mm. The steel used was a known carbon steel (US standard AISI 1069) with a carbon content of 0.70%. The wires of intermediate diameter underwent a degreasing and/or pickling treatment before their subsequent conversion. After a brass coating had been applied to these intermediate wires, what is called a “final” work-hardening operation was carried out on each wire (i.e. after the final patenting heat treatment) by cold-drawing in a wet medium with a drawing lubricant for example in the form of an aqueous emulsion or dispersion. The brass coating surrounding the wires had a very small thickness, markedly lower than 1 micron, for example of the order of 0.15 to 0.30 μm, which is negligible by comparison with the diameter of the steel wires. The steel wires thus drawn had the diameter and mechanical properties shown in Table 1 below.

TABLE 1

| Steel | φ (mm) | Fm (N) | Rm (MPa) |
|---|---|---|---|
| NT | 0.18 | 68 | 2820 |

These wires were then assembled in the form of 2+8+14 layered cords the construction of which is as shown in FIG. 1 and the mechanical properties of which are given in Table 2.

TABLE 2

| | p₁ | p₂ | p₃ | Fm | Rm | At |
|---|---|---|---|---|---|---|
| Cord | (mm) | (mm) | (mm) | (daN) | (MPa) | (%) |
| C-1 | 6 | 12 | 18 | 155 | 2680 | 2.4 |

This 2+8+14 cord example of the invention (C-1), prepared according to the method described above, as depicted schematically in FIG. 1, is therefore made up of 24 wires in total, two wires forming the central layer (C1) and 22 wires around all of diameter 0.18 mm, which have been wound in three concentric layers with different pitches (same direction of twist S) to obtain a cord having cylindrical layers. The filling rubber content, measured using the method indicated above at paragraph II-1-C, was about 32 mg per g of cord. This filling rubber was present in each of the capillaries of the cord, i.e. it completely or at least partly filled each of these capillaries such that, over any 3 cm (even preferably 2 cm) length of cord, there was at least one plug of rubber in each capillary.

To manufacture this cord, use was made of a device as described hereinabove and schematically depicted in FIG. 3. The filling rubber was a conventional rubber composition for the carcass reinforcement of a tire for industrial vehicles, having the same formulation as the rubber carcass ply that the cord C-1 was intended to reinforce; this composition was based on natural (peptized) rubber and on N330 carbon black (55 phr); it also contains the following usual additives: sulphur (6 phr), sulfenamide accelerator (1 phr), ZnO (9 phr), stearic acid (0.7 phr), antioxidant (1.5 phr), cobalt naphthenate (1 phr); the E10 modulus of the composition was around 6 MPa. This composition was extruded at a temperature of around 85° C. through a single sizing die of about 0.420 mm in diameter.

The cords C-1 thus prepared were subjected to the air permeability test described at paragraph II-1-B, measuring the volume of air (in cm³) passing through the cords in 1 minute (average over 10 measurements for each cord tested). For each cord C-1 tested and for 100% of the measurements (i.e. ten specimens out of ten), a flow rate of zero or of less than 0.2 cm³/min was measured; in other words, these examples of cords prepared according to the method of the invention can be termed airtight along their longitudinal axis; they therefore have an optimum level of penetration by the rubber.

Furthermore, control cords rubberized in situ and of the same construction as the compact cords C-1 above were prepared in accordance with the method described in the aforementioned application WO 2005/071157, in several discontinuous steps, sheathing the intermediate 2+8 core strand using an extrusion head, then in a second stage cabling the remaining 15 wires around the core thus sheathed, to form the outer layer. These control cords were then subjected to the air permeability test of paragraph I-2.

It was noted first of all that none of these control cords gave 100% (i.e. ten specimens out of ten) measured flow rates of zero or less than 0.2 cm³/min, or in other words that none of these control cords could be termed airtight (completely airtight) along its axis.

It was also found that, of these control cords, those which exhibited the best impermeability results (i.e. an average flow rate of around 2 cm³/min) all had a relatively large amount of unwanted filling rubber overspilling from their periphery, making them ill suited to a satisfactory calendaring operation under industrial conditions.

To sum up, the method of the invention allows the manufacture of cords of 2+M+N construction rubberized in situ and which, by having an optimal level of penetration by rubber, on the one hand exhibit high endurance in tire carcass reinforcements and on the other hand can be used effectively under industrial conditions, notably without the difficulties connected with an excessive overspill of rubber during their manufacture.

Of course, the invention is not limited to the embodiments described hereinabove.

Thus, for example, at least one (i.e. one or more) wire of the cord of the invention, whichever layer (C1, C2 or C3) is considered could be replaced by a preformed or deformed wire or, more generally, by a wire of a cross section different from that of the other wires of diameter d₁ and/or d₂ and/or d₃, so as, for example, to further improve the penetrability of the cord by the rubber or any other material, it being possible for the envelope diameter of this replacement wire to be less than, equal to or greater than the diameter (d₁ and/or d₂ and/or d₃) of the other wires that make up the relevant layer (C1 and/or C2 and/or C3).

Without altering the spirit of the invention, some of the wires that make up the cord according to the invention could be replaced by wires other than steel wires, metallic or otherwise, and could notably be wires or threads made of an inorganic or organic material of high mechanical strength, for example monofilaments made of liquid crystal organic polymers.

The invention also relates to any multiple strand steel cord (“multi-strand rope”) the structure of which incorporates at least, by way of elementary strand, a layered cord according to the invention.

By way of example of multi-strand ropes according to the invention, which can be used for example in tires for industrial vehicles of the civil engineering type, notably in their carcass or crown reinforcement, mention may be made of multi-strand ropes with two layers (J+K) of strands of overall construction known per se, for example:
(1+5)×(2+M+N) made up in total of six elementary strands, one at the centre and the other five cabled around the centre;
(1+6)×(2+M+N) made up in total of seven elementary strands, one at the centre and the other six cabled around the centre;
(2+7)×(2+M+N) made up in total of nine elementary strands, two at the centre and the other seven cabled around the centre;
(2+8)×(2+M+N) made up in total of ten elementary strands, two at the centre and the other eight cabled around the centre;
(3+8)×(2+M+N) made up in total of eleven elementary strands, three at the centre and the other eight cabled around the centre;
(3+9)×(2+M+N) made up in total of twelve elementary strands, three at the centre and the other nine cabled around the centre;
(4+9)×(2+M+N) formed in total of thirteen elementary strands, three at the centre and the other nine cabled around the centre;
(4+10)×(2+M+N) made up in total of fourteen elementary strands, four at the centre and the other ten cabled around the centre,
   but in which each elementary strand (or at the very least, at least part of them) is made up of a 2+M+N, notably 2+7+13 or 2+8+14, three-layered cord which is in accordance with the invention.

Such multi-strand steel ropes, notably of the types (1+5)(2+7+13), (1+6)(2+7+13), (2+7)(2+7+13), (2+8)(2+7+13), (3+8)(2+7+13), (3+9)(2+7+13), (4+9)(2+7+13), (4+10)(2+7+13), (1+5)(2+8+14), (1+6)(2+8+14), (2+7)(2+8+14), (2+8)(2+8+14), (3+8)(2+8+14), (3+9)(2+8+14), (4+9)(2+8+14) or (4+10)(2+8+14), may themselves be rubberized in situ at the time of their manufacture, which means to say that in this case the central strand is itself, or the strands at the centre if there are several of them are themselves, sheathed with unvalcanized filling rubber (this filling rubber being of the same or a different formulation compared with that used for the in-situ rubberizing of the elementary strands), before the peripheral strands that form the outer layer are set in place by cabling.

1. A metal cord with three layers of 2+M+N construction, rubberized in situ, comprising a first layer or central layer comprised of two wires of diameter d₁ assembled in a helix at a pitch p₁, around which central layer there are wound in a helix at a pitch p₂, in a second layer, M wires of diameter d₂, around which second layer there are wound in a helix at a pitch p₃, in a third layer, N wires of diameter d₃, wherein the cord has the following characteristics (d₁, d₂, d₃, p₁, p₂ and p₃ being expressed in mm):
0.08≦d₁≦0.50;
0.08≦d₂≦0.50;
0.08≦d₃≦0.50;
3<p₁<50;
6<p₂<50;
9<p₃<50;
over any 3 cm length of cord, a rubber composition called “filling rubber” is present in each of the capillaries delimited by, on the one hand, the 2 wires of the first layer and the M wires of the second layer, and on the other hand the M wires of the second layer and the N wires of the third layer;
the content of filling rubber in the cord is comprised between 10 and 50 mg per gram of cord.

2. The cord according to claim 1, wherein the rubber of the filling rubber is a diene elastomer.

3. The cord according to claim 2, wherein the diene elastomer is chosen from the group consisting of polybutadienes, natural rubber, synthetic polyisoprenes, copolymers of butadiene, copolymers of isoprene, and blends of these elastomers.

4. The cord according to claim 3, wherein the diene elastomer is an isoprene elastomer.

5. The cord according to claim 1, wherein the following characteristics are satisfied:
3<p₁<30;
6<p₂<30;
9<p₃<30.

6. The cord according to claim 1, wherein:
p₁≦p₂≦p₃.

7. The cord according claim 1, wherein to the following characteristics are satisfied:
0.10≦d₁≦0.40;
0.10≦d₂≦0.40;
0.10≦d₃≦0.40.

8. The cord according to claim 1, wherein the 2, M and N wires of the first, second and third layers are wound in the same direction of twisting.

9. The cord according to claim 1, wherein d₁=d₂=d₃.

10. The cord according to claim 1, wherein p₂=p₃.

11. The cord according to claim 1, wherein the second layer comprises 6 to 10 wires, and the third layer comprises 12 to 16 wires.

12. The cord according to claim 11, wherein the second layer comprises 7 or 8 wires and the third layer comprises 13 or 14 wires.

13. The cord according to claim 1, wherein the third layer is a saturated layer.

14. The cord according to claim 1, wherein the content of filling rubber is comprised between 15 and 45 mg.

15. The cord according to claim 1, wherein, in an air permeability test, it has an average air flow rate of less than 2 cm³/min.

16. The cord according to claim 15, wherein, in the air permeability test, it has an air flow rate less than or at the most equal to 0.2 cm³/min.

17. A method of manufacturing a cord according to claim 1, comprising the following steps:
a first step of assembling by twisting the two wires of the central layer to form, at a first point called “first assembling point” the first layer or central layer;
a second assembling step by twisting the M wires around the central layer to form, at a second point called “second assembling point” an intermediate cord (C1+C2) called “core strand” of 2+M construction;
downstream of the first assembling point, a sheathing step in which the central layer and/or the core strand (C1+C2) is/are sheathed with a filling rubber in the uncured state, this sheathing being conducted either upstream or downstream or both upstream and downstream of the second assembling point;
followed by a third assembling step by twisting or cabling the N wires around the core strand thus sheathed;
then a twist-balancing step.

18. A multi-strand rope at least one of the strands of which is a cord according to claim 1.

19. (canceled)

20. (canceled)

21. A tire comprising a cord according to claim 1.

22. The tire according to claim 21, said tire being a tire of an industrial vehicle.

23. The tire according to claim 21, the cord being present in the carcass reinforcement or the crown reinforcement of the tire.

24. The cord according to claim 3, wherein the diene elastomer is natural rubber.

24. The cord according to claim 1, wherein the content of filling rubber is between 15 and 40 mg per g of cord
